(19) United States
(12) Patent Application Publication
(10) Pub. No.: US 2018/0261148 A1
(43) Pub. Date: Sep. 13, 2018

(54) DISPLAY SYSTEM AND METHOD FOR AN AIRCRAFT

(71) Applicant: Airbus Operations (S.A.S.), Toulouse (FR)

(72) Inventors: Javier Manjon Sanchez, TOULOUSE (FR); Cedric Descheemaeker, BEAUZELLE (FR)

(21) Appl. No.: 15/910,842

(22) Filed: Mar. 2, 2018

(30) Foreign Application Priority Data
Mar. 9, 2017 (FR) 1751917

(51) Int. Cl. G09G 3/20; G06T 11/60; G06F 3/01; B64D 43/00

(52) U.S. Cl. CPC G09G 3/2096; G06T 11/60; G06F 3/012; G09G 2380/12; B64D 43/00; G09G 2354/00; G09G 2340/12; G06F 3/015

(57) ABSTRACT

A display system and method for an aircraft including a head wearable display device, a display computer, a sensor of position and orientation of the user head and a database of interior cockpit geometry. In a procedures management assistance mode, the display computer can receive, from a procedures management computer, at least one item of information relating to a first control element of the cockpit. The display computer can determine a position of display of a symbol on the display device, as a function of the position of the first control element, acquired from the database and from information regarding position and orientation of the head of the user in the cockpit acquired from the sensor, such that this symbol is visible by the user, superimposed on the first control element. The display computer can command the display of the symbol on the display device.

### CROSS-REFERENCE TO RELATED APPLICATION

This patent application claims priority to French patent application FR 17 51917, filed on Mar. 9, 2017, the entire disclosure of which is incorporated by reference herein.

### TECHNICAL FIELD

The disclosure herein relates to systems and methods for display of piloting aid information in an aircraft cockpit.

### BACKGROUND

Modern aircraft, in particular transport aeroplanes, generally comprise a system for displaying piloting aid information in their cockpit. Such a system, for example of CDS (“Control and Display System”) type, controls the display of information on screens of the cockpit. This system generally comprises a screen configured to display procedures (“checklists”) having to be carried out by a pilot of the aircraft. This screen is for example a screen of ECAM (“Electronic Centralized Aircraft Monitor”) type, which is associated with at least one procedures management computer controlling the display of the procedures on this screen. To carry out the procedures displayed on this screen, the pilot must in particular interact with control elements of the cockpit such as for example buttons situated on panels of the ceiling of the cockpit, knobs for controlling the thrust of the engines of the aircraft, etc. However, an aircraft cockpit comprises a large number of such control elements. It would consequently be beneficial to aid the pilot to rapidly identify a control element on which he must act so as to facilitate the piloting of the aircraft. Document U.S. Pat. No. 7,260,453B2 describes a system which illuminates a control element of the cockpit on which the pilot is presumed to act, by a set of spotlights disposed in the cockpit so as to allow the illumination of the set of control elements of the cockpit. The use of the spotlights requires that they be installed in the cockpit, so this must be provided for when designing the aircraft's cockpit. Moreover, an aircraft cockpit comprising a large number of control elements and of display screens, it may be difficult to find appropriate locations for installing the spotlights. In a variant, the system comprises a display surrounding the control elements or located in proximity. This requires significant wiring which turns out to be expensive and which gives rise to an increase in the mass of the aircraft. A need therefore exists for a system for aiding the pilot to rapidly identify a control element on which he must act, which would not require complex and expensive installation in the cockpit of the aircraft.

### SUMMARY

An aim of the present disclosure is in particular to afford a solution to these problems. It relates to a display system for a cockpit of an aircraft comprising a set of control elements, the display system comprising:
a display device configured to be worn fastened to the head of a user in the cockpit of the aircraft;
a display computer configured to control the display of information on the display device;
a sensor of position and of orientation of the head of the user in the cockpit; and
a database comprising information regarding interior geometry of the cockpit.

The display system is noteworthy in that it comprises a mode of operation termed assistance with the management of procedures, in which the display computer is configured to:
receive, from a procedures management computer of the aircraft, at least one item of information relating to a first control element of the cockpit on which an action of the user is expected;
acquire, from the database, information regarding position of the first control element in the cockpit;
acquire information, provided by the sensor, regarding position and orientation of the head of the user in the cockpit;
determine a position of display of a symbol on the display device, as a function of the position of the first control element in the cockpit and of the information regarding position and orientation of the head of the user in the cockpit, in such a way that this symbol is visible by the user, superimposed on the first control element; and
command the display of the symbol on the display device.

Thus, when the procedures management assistance mode is activated, the display system commands the display of a symbol on the display device, superimposed on the first control element visible by the user through the display device. This allows the user to rapidly and easily identify the first control element by which he must carry out an action requested in a procedure managed by the procedures computer. The display system exhibits the advantage of not requiring specific installation in the cockpit of the aircraft, since the display is carried out by the display device worn fastened to the user's head.

In one embodiment, in the procedures management assistance mode, the display computer is furthermore configured to command the display on the display device, in proximity to the symbol, of an aid item of information relating to the expected action of the user on the first control element of the cockpit.

In an advantageous embodiment, the display system comprises a second sensor configured to detect at least one part of a hand of the user in a detection volume of the second sensor, and, in the procedures management assistance mode, the display computer is furthermore configured to:
acquire information from the second sensor;
determine whether the information acquired from the second sensor corresponds to the presence of a part of a hand of the user in the detection volume of the second sensor; and
if the information acquired from the second sensor corresponds to the presence of a part of a hand of the user:
   determine a position of the part of the hand of the user in the cockpit;
   as a function of the position of the part of the hand of the user in the cockpit, search the database for information making it possible to determine whether there exists a control element of the cockpit situated at a distance from the part of the hand of the user that is smaller than a distance threshold; and
   if there exists a control element of the cockpit, other than the first control element, situated at a distance from the part of the hand of the user that is smaller than this distance threshold, command the display of a user warning item of information on the display device.

In particular, the second sensor is configured to detect the at least one part of a hand of the user, the part of the hand comprising at least one part of a finger, in particular an end of the finger.

In an advantageous manner, the second sensor is fastened to the display device. It corresponds in particular to an optical sensor.

According to a first variant, the display system furthermore comprises a device for activating the procedures management assistance mode, and the display computer is configured to activate or deactivate the procedures management assistance mode as a function of actions of the user on the device for activating the procedures management assistance mode.

According to a second variant, the display system furthermore comprises at least one sensor of physiological signals of the user and the display computer is configured to:
acquire information from the at least one sensor of physiological signals;
determine a stress level of the user as a function of the information acquired from the at least one sensor of physiological signals;
compare the user's stress level with a predetermined stress level;
activate the procedures management assistance mode if the user's stress level is greater than the predetermined stress level.

According to a third variant, the display computer is configured to:
receive, from the procedures management computer, at least one item of information relating to an inappropriate behavior of the user;
activate the procedures management assistance mode when it receives this item of information relating to an inappropriate behavior of the user.

The disclosure herein also relates to a display method for a cockpit of an aircraft, the aircraft comprising a set of control elements in the cockpit, a procedures management computer and a display system comprising:
a display device configured to be worn fastened to the head of a user in the cockpit of the aircraft;
a display computer configured to control the display of information on the display device;
a sensor of position and of orientation of the head of the user in the cockpit; and
a database comprising information regarding interior geometry of the cockpit.

The method is noteworthy in that, in a mode of operation termed assistance with the management of procedures of the display system, the method comprises the following steps implemented by the display computer:
receiving, from the procedures management computer, at least one item of information relating to a first control element of the cockpit on which an action of the user is expected;
acquiring, from the database, information regarding position of the first control element in the cockpit;
acquiring information, provided by the sensor, regarding position and orientation of the head of the user in the cockpit;
determining a position of display of a symbol on the display device, as a function of the position of the first control element in the cockpit and of the information regarding position and orientation of the head of the user in the cockpit, in such a way that this symbol is visible by the user, superimposed on the first control element; and
commanding the display of the symbol on the display device.

In an advantageous embodiment, the display system comprising a second sensor configured to detect at least one part of a hand of the user in a detection volume of the second sensor, in the procedures management assistance mode the method furthermore comprises the following steps implemented by the display computer:
acquiring information from the second sensor;
determining whether the information acquired from the second sensor corresponds to the presence of a part of a hand of the user in the detection volume of the second sensor; and
if the information acquired from the second sensor corresponds to the presence of a part of a hand of the user:
   determining a position of the part of the hand of the user in the cockpit;
   as a function of the position of the part of the hand of the user in the cockpit, searching the database for information making it possible to determine whether there exists a control element of the cockpit situated at a distance from the part of the hand of the user that is smaller than a distance threshold; and
   if there exists a control element of the cockpit, other than the first control element, situated at a distance from the part of the hand of the user that is smaller than this distance threshold, commanding the display of a user warning item of information on the display device.

The disclosure herein also relates to an aircraft comprising a display system such as disclosed herein.

### BRIEF DESCRIPTION OF THE DRAWINGS

The disclosure herein will be better understood on reading the description which follows and on examining the appended, example figures.

FIG. 1 illustrates in a simplified manner an aircraft comprising a cockpit.

FIGS. 2a and 2b illustrate in a schematic manner embodiments, in accordance with the disclosure herein, of a display system for a cockpit of an aircraft.

FIGS. 3a, 3b and 3c illustrate the orientation of the head of a user of the display system, respectively viewed from above, in a side view and viewed from behind.

FIGS. 4a, 4b and 5 illustrate examples of display, on a display device worn fastened to the head of a user.

### DETAILED DESCRIPTION

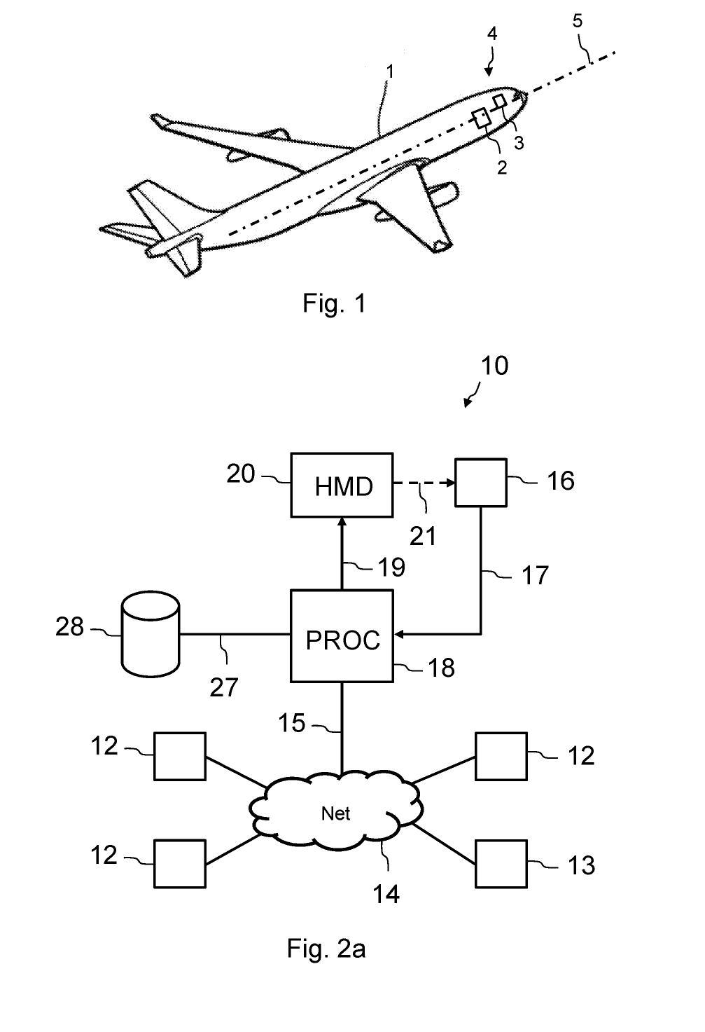

The aircraft 1 represented in FIG. 1 comprises a cockpit 3 in a front part 4 of the aircraft. It comprises a longitudinal axis 5, corresponding to a roll axis of the aircraft. This longitudinal axis is substantially horizontal when the aircraft is parked on the ground. The aircraft also comprises a yaw axis (not represented), substantially vertical when the aircraft is parked on the ground. By convention, in the subsequent description, the term horizontal designates a straight line or a plane which is substantially horizontal when the aircraft is parked on the ground, in such a way that this straight line or this plane is perpendicular to the yaw axis of the aircraft. In an analogous manner, the term vertical designates a straight line or a plane which is substantially vertical when the aircraft is parked on the ground, in such a way that this straight line or this plane is parallel to (or contains) the yaw axis of the aircraft.

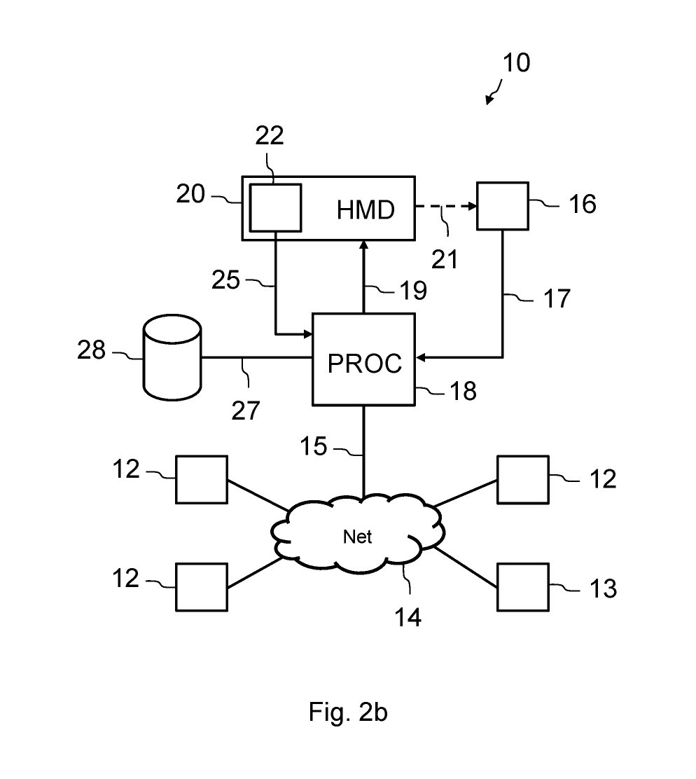

The display system 10 in accordance with an embodiment of the disclosure herein and represented in FIG. 2a comprises a display computer 18 comprising a processing unit (labelled PROC in the figure). This processing unit can in particular correspond to a processor or a microprocessor of the display computer. According to various embodiments, the display computer 18 is a common display computer controlling several display devices of the aircraft or else a computer dedicated to the display system 10. In a particular embodiment, this computer corresponds to a computer of modular avionics type IMA (“Integrated Modular Avionics”) also supporting functions other than display. The display computer 18 is connected to at least one procedures management computer 13 of the aircraft. In the particular example represented in FIG. 2a, the display computer is connected to the procedures management computer 13 by a link 15 and a communication network 14 (labelled “Net” in the figure) to which are also connected the procedures management computer 13 as well as avionics computers 12. The procedures management computer 13 and the avionics computers 12 are for example situated in an avionics bay 2 of the aircraft. The display system 10 furthermore comprises a display device 20 configured to be worn fastened to the head of a user, in particular of a pilot, in the cockpit of the aircraft. This display device is connected to the display computer 18 by a link 19. This display device 20 corresponds to a display device commonly called HMD for “Head Mounted Display”. It is sometimes also called HWD for “Head Worn Display”. It comprises a display mounted fastened to glasses or to a headset, in such a way that the user can see information displayed on the display when he wears these glasses or this headset. The display is semi-reflecting in such a way that the user can view the displayed information, in augmented reality, superimposed on the environment. In the subsequent description, the term HMD designates either an HMD device or an HWD device. The display system 10 furthermore comprises a sensor 16 of orientation and of position of the head of the user and a database 28 comprising information regarding interior geometry of the cockpit. The sensor 16 of orientation and of position of the head of the user is connected to the display computer 18 by a link 17 and the database 28 is connected to the display computer 18 by a link 27. In a particular embodiment, the sensor 16 is mounted fastened to the display device 20, as symbolized by the dashed arrow 21. It then corresponds, for example, to a set of inertial sensors integrated into the display device 20. In another particular embodiment, the sensor 16 is mounted fastened to the cockpit 3 of the aircraft. It then corresponds, for example, to a camera disposed so as to automatically monitor the relative position of the head of the user of the display device 20 with respect to the cockpit. Without departing from the scope of the disclosure herein, the sensor 16 can correspond to a group of sensors, for example a sensor of orientation of the head of the user and a sensor of position of the head of the user. The information regarding interior geometry of the cockpit, contained in the database 28, arises for example from a digital mockup of the aircraft or the cockpit of the aircraft, in particular from a three-dimensional digital mockup. In an advantageous manner, this geometry information is simplified with respect to information regarding the digital mockup of the aircraft, so as to reduce the volume of the information as well as the computation times. This information, contained in the database 28, regarding interior geometry of the cockpit relates at least to control elements of the cockpit, such as for example buttons situated on control panels of the cockpit, knobs for controlling the thrust of the engines of the aircraft, etc.

In operation, when a procedure must be executed by a user, in particular a pilot of the aircraft, the procedures management computer 13 displays this procedure on a screen of ECAM type of the cockpit of the aircraft. The display system 10 comprises a procedures management assistance mode. When the procedures management assistance mode is activated, the procedures management computer 13 transmits to the display computer 18, through the communication network 14, an item of information relating to a first control element of the cockpit on which an action of the user is expected in respect of the execution of the procedure. The display computer 18, which receives this item of information, then interrogates the database 28 to acquire information regarding position of the first control element in the cockpit. It also acquires information, provided by the sensor 16, regarding position and orientation of the head of the user in the cockpit. As a function of the position of the first control element in the cockpit and of the information regarding position and orientation of the head of the user in the cockpit, the display computer 18 determines a position of display of a symbol on the display device 20, in such a way that this symbol is visible by the user, superimposed on the first control element. The display computer 18 then commands the display of the symbol on the display device 20.

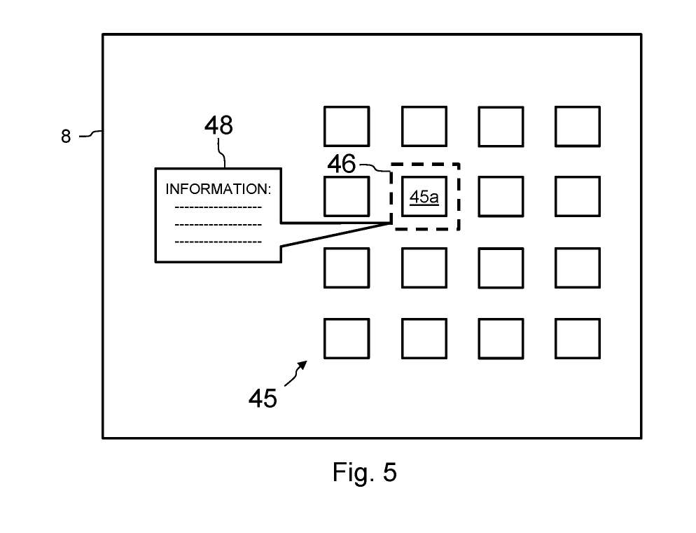

In an example illustrated by FIG. 5, the user can see a set of control elements 45 of the cockpit through the display 8 of the display device 20. These control elements correspond in particular to buttons of a control panel situated on the ceiling of the cockpit. According to the procedure currently being executed, the user must perform an action on a first element 45a of the set of control elements 45. As described previously, the display computer 18 commands the display of a symbol 46 superimposed on the first control element 45a. In the example illustrated by the figure, the symbol 46 corresponds to a frame surrounding the first control element 45a. Other types of representations of the symbol are possible without departing from the scope of the disclosure herein.

In an advantageous manner, the display computer 18 is furthermore configured to command the display on the display device 20, in proximity to the symbol 46, of an aid item of information 48 relating to the user's next expected action on the first control element 45a of the cockpit. Accordingly, in addition to the item of information relating to the first control element, the display computer 18 receives, from the procedures management computer 13, either the aid item of information 48, or an identifier of the aid item of information. The display of the aid item of information 48 makes it possible to inform the user of the next action to be carried out by the first control element 45a.

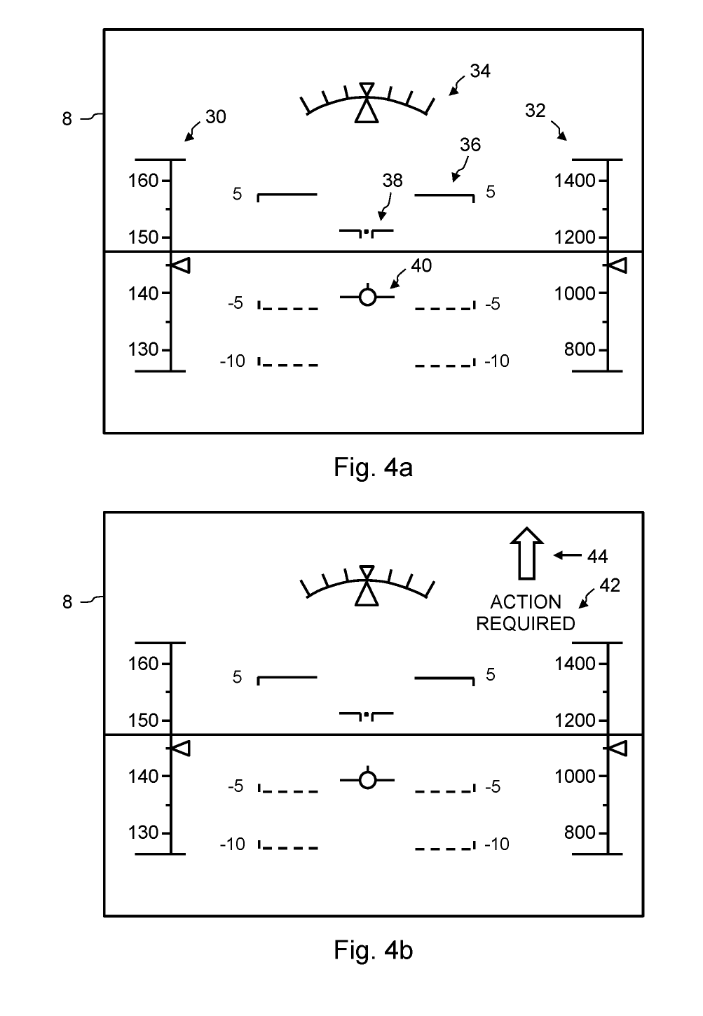

In particular circumstances, the user might not be looking in the direction of the first control element 45a when an action on this first control element is required by the procedure. FIG. 4a illustrates such a situation, in which the user is looking outside the aircraft through a windscreen of the cockpit. The display on the display 8 of the display device 20 then comprises, for example, an aircraft reference symbol 38, a speed vector symbol 40 for the aircraft and an attitude scale 36 for the aircraft, all displayed in a compliant manner with respect to the environment of the aircraft. The display also comprises an altitude scale 32, a speed scale 30 and a roll scale 34 for the aircraft. In such a situation, the symbol 46 cannot be displayed superimposed on the first control element 45a. The display computer 18 then determines a direction towards which the user must turn his head to see the first control element 45a and it displays an arrow pointing in this direction. In an example illustrated by FIG. 4b, the user is looking through a windscreen of the cockpit, towards the front of the aircraft, and the first control element 45a is situated on a control panel of the ceiling of the cockpit. Consequently, the display computer 18 commands the display, on the display 8, of an arrow 44 pointing upwards. In an advantageous manner, the display computer 18 furthermore commands the display of an item of information 42 in proximity to the arrow 44 so as to inform the user that an action on his part is required. If he turns his head upwards, the user then accesses the display, already described, illustrated by FIG. 5.

In an advantageous embodiment illustrated by FIG. 2b, the display system 10 furthermore comprises a second sensor 22 configured to detect at least one part of a hand of the user in a detection volume of the second sensor. In a first example, when the first control element corresponds to a knob for controlling the thrust of the engines, this part of a hand of the user corresponds to any part of the hand that might act on the knob. In a second example, when the first control element on which an action of the user is expected corresponds to a button, this part of a hand of the user corresponds to a part of a finger of the user, preferably at least to an end of the finger with which the user might press the button. The second sensor 22, which corresponds for example to an optical sensor such as a camera, is connected to the display computer 18 by a link 25. According to a first alternative, the second sensor 22 is integrated into the display device 20 as illustrated in the figure. According to a second alternative, the second sensor 22 is integrated into the cockpit of the aircraft. In the procedures management assistance mode, the display computer is furthermore configured to acquire information from the second sensor 22 and to determine whether the information acquired from the second sensor corresponds to the presence of a part of a finger of the user in the detection volume of the second sensor (within the framework of the second aforementioned example). If the information acquired from the second sensor corresponds to the presence of a part of a finger of the user, the display computer 18 determines a position of the part of the finger of the user in the cockpit and as a function of the position of the part of the finger of the user in the cockpit, it searches the database 28 for information making it possible to determine whether there exists a control element of the cockpit situated at a distance from the part of the finger of the user that is smaller than a distance threshold. If there exists a control element of the cockpit, other than the first control element 45a, situated at a distance from the part of the finger of the user that is smaller than this distance threshold, the display computer 18 commands the display of a user warning item of information on the display device 20. This makes it possible to afford the user better assistance by monitoring his actions on the control elements of the cockpit and by warning him when he risks acting on a control element other than that envisaged in the procedure. The system is particularly advantageous, since it makes it possible for the warning to be given earlier, even before the user performs an action on this other control element, by detecting the presence of a part, preferably an end, of a finger of the user in proximity to the other control element.

According to a first variant, the display system furthermore comprises a device for activating the procedures management assistance mode. This device corresponds for example to a button of the cockpit of the aircraft or to a man-machine interface of the cockpit, comprising a display screen as well as a keyboard and/or a pointing unit of trackball or mouse type. As a function of actions of the user on the device for activating the procedures management assistance mode, this device for activating the procedures management assistance mode transmits information to the procedures management computer 13, according to a first alternative, or to the display computer 18, according to a second alternative. As a function of the information, the procedures management computer 13 or the display computer 18 activates or deactivates the procedures management assistance mode. In the first alternative, the procedures management computer 13 informs the display computer 18 of the activation or of the deactivation of the procedures management assistance mode.

According to a second variant, the display system furthermore comprises at least one sensor of physiological signals of the user. This at least one sensor is for example mounted fastened to the HMD display device 20. According to a first variant, this sensor corresponds to one or more electrodes intended to be placed on the head of the user when the latter wears the HMD display device. These electrodes make it possible to measure electroencephalography signals, these signals reflecting the activity of the user's brain. According to a second variant that can be coupled with the first variant, the sensor uses infrared signals of FLIR (“Forward Looking InfraRed”) type to measure a temperature of the user's head. The display computer 18 acquires information from the at least one sensor of physiological signals and it determines a stress level of the user as a function of the information acquired from the at least one sensor of physiological signals. The display computer 18 compares the user's stress level with a predetermined stress level and it activates the procedures management assistance mode if the user's stress level is greater than the predetermined stress level. Thus, the procedures management assistance mode is activated automatically when the user's stress level exceeds the predetermined stress level.

According to a third variant, the display computer 18 activates the procedures management assistance mode when it receives, from the procedures management computer 13, an item of information relating to an inappropriate behavior of the user. Thus, the procedures management assistance mode is activated automatically when the user does not perform expected actions within the framework of a procedure.

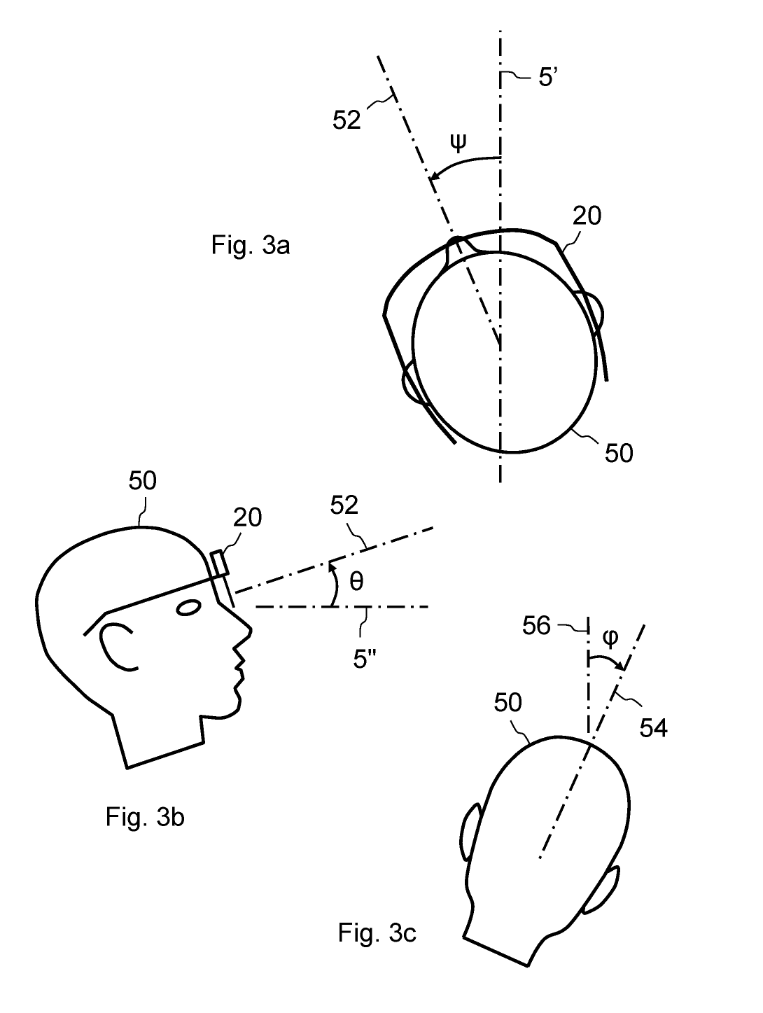

In an advantageous embodiment, the item of information regarding orientation of the head of the user corresponds to at least one angle from among a set of angles, such as are illustrated by FIGS. 3a, 3b and 3c. In these figures, the orientation of the user's head 50 is represented by a straight line 52. In an exemplary embodiment, this straight line 52 corresponds to a theoretical direction of the gaze of the user when he is looking in front of himself without turning his eyes either to the right or to the left and without raising or lowering his eyes. Other definitions of the orientation of the head of the user are however possible without departing from the scope of the disclosure herein. In the advantageous embodiment, the item of information regarding orientation of the head of the user corresponds to at least one angle from among an angle of yaw iv, an angle of pitch θ and an angle of roll φ illustrated respectively by FIGS. 3a, 3b and 3c. These angles are defined in a reference frame related to the aircraft. Thus, the angle of yaw ψ is an angle, defined in projection in a horizontal plane, between a straight line 5′ parallel to the longitudinal axis 5 of the aircraft and the straight line 52 representing the orientation of the user's head. The angle of pitch θ is an angle, defined in projection in a vertical plane parallel to the longitudinal axis 5 of the aircraft, between a straight line 5″ parallel to the longitudinal axis 5 of the aircraft and the straight line 52 representing the orientation of the user's head. The angle of roll φ is for its part an angle defined in projection in a vertical plane perpendicular to the longitudinal axis 5 of the aircraft, between a vertical straight line 56 and a yaw axis 54 of the user's head. The item of information regarding orientation of the user's head acquired by the display computer 18 corresponds to at least one of the angles ψ, θ and φ.

In a still advantageous manner, the item of information regarding position of the user's head corresponds to Cartesian coordinates of the centre of gravity of the head 50 in an orthonormal reference frame. In a particular manner, a first axis of the orthonormal reference frame is parallel to the longitudinal axis 5, a second axis of the orthonormal reference frame is vertical and a third axis of the orthonormal reference frame is horizontal and perpendicular to the first two axes.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A display system for a cockpit of an aircraft comprising a set of control elements, the display system comprising:
a display device configured to be worn fastened to a head of a user in the cockpit of the aircraft;
a display computer configured to control display of information on the display device;
a sensor of position and of orientation of the head of the user in the cockpit; and
a database comprising information regarding interior geometry of the cockpit,
the display system comprising a mode of operation termed assistance with management of procedures, in which the display computer is configured to:
receive, from a procedures management computer of the aircraft, at least one item of information relating to a first control element of the cockpit on which an action of the user is expected;
acquire, from the database, information regarding position of the first control element in the cockpit;
acquire information, provided by the sensor, regarding position and orientation of the head of the user in the cockpit;
determine a position of display of a symbol on the display device, as a function of the position of the first control element in the cockpit and of the information regarding position and orientation of the head of the user in the cockpit, such that the symbol is visible by the user, superimposed on the first control element; and
command the display of the symbol on the display device.

2. The display system according to claim 1, wherein, in the procedures management assistance mode, the display computer is further configured to command the display on the display device, in proximity to the symbol, of an aid item of information relating to an expected action of the user on the first control element of the cockpit.

3. The display system according to claim 1, comprising a second sensor configured to detect at least one part of a hand of the user in a detection volume of the second sensor and, in the procedures management assistance mode, the display computer is further configured to:
acquire information from the second sensor;
determine whether the information acquired from the second sensor corresponds to presence of a part of a hand of the user in the detection volume of the second sensor; and
if the information acquired from the second sensor corresponds to the presence of a part of a hand of the user:
determine a position of the part of the hand of the user in the cockpit;
as a function of the position of the part of the hand of the user in the cockpit, search the database for information making it possible to determine whether there exists a control element of the cockpit situated at a distance from the part of the hand of the user that is smaller than a distance threshold; and
if there exists a control element of the cockpit, other than the first control element, situated at a distance from the part of the hand of the user that is smaller than this distance threshold, command the display of a user warning item of information on the display device.

4. The display system according to claim 3, wherein the second sensor is configured to detect the at least one part of a hand of the user, the part of the hand comprising at least one part of a finger, in particular an end of the finger.

5. The display system according to claim 4, wherein the second sensor is fastened to the display device.

6. The display system according to claim 3, wherein the second sensor is an optical sensor.

7. The display system according to claim 1, further comprising a device for activating the procedures management assistance mode, and wherein the display computer is configured to activate or deactivate the procedures management assistance mode as a function of actions of the user on the device for activating the procedures management assistance mode.

8. The display system according to claim 1, further comprising at least one sensor of physiological signals of the user and wherein the display computer is configured to:
acquire information from the at least one sensor of physiological signals;
determine a stress level of the user as a function of the information acquired from the at least one sensor of physiological signals;
compare the user's stress level with a predetermined stress level;
activate the procedures management assistance mode if the user's stress level is greater than the predetermined stress level.

9. The display system according to claim 1, wherein the display computer is configured to:
receive, from the procedures management computer, at least one item of information relating to an inappropriate behavior of the user;
activate the procedures management assistance mode when it receives this item of information relating to an inappropriate behavior of the user.

10. A display method for a cockpit of an aircraft, the aircraft comprising a set of control elements in the cockpit, a procedures management computer and a display system comprising:
a display device configured to be worn fastened to a head of a user in the cockpit of the aircraft;
a display computer configured to control display of information on the display device;
a sensor of position and of orientation of the head of the user in the cockpit; and
a database comprising information regarding interior geometry of the cockpit,
wherein in a mode of operation termed assistance with management of procedures of the display system, the method comprises steps implemented by the display computer, the steps comprising:
receiving, from the procedures management computer, at least one item of information relating to a first control element of the cockpit on which an action of the user is expected;
acquiring, from the database, information regarding position of the first control element in the cockpit;
acquiring information, provided by the sensor, regarding position and orientation of the head of the user in the cockpit;
determining a position of display of a symbol on the display device, as a function of the position of the first control element in the cockpit and of the information regarding position and orientation of the head of the user in the cockpit, in such a way that this symbol is visible by the user, superimposed on the first control element; and
commanding the display of the symbol on the display device.

11. The display method according to claim 10, wherein the display system comprises a second sensor configured to detect at least one part of a hand of the user in a detection volume of the second sensor, in the procedures management assistance mode the method further comprises steps implemented by the display computer, the steps comprising:
acquiring information from the second sensor;
determining whether information acquired from the second sensor corresponds to presence of a part of a hand of the user in the detection volume of the second sensor; and
if the information acquired from the second sensor corresponds to the presence of a part of a hand of the user:
determining a position of the part of the hand of the user in the cockpit;
as a function of the position of the part of the hand of the user in the cockpit, searching the database for information making it possible to determine whether there exists a control element of the cockpit situated at a distance from the part of the hand of the user that is smaller than a distance threshold; and
if there exists a control element of the cockpit, other than the first control element, situated at a distance from the part of the hand of the user that is smaller than this distance threshold, commanding the display of a user warning item of information on the display device.

12. An aircraft comprising a display system for a cockpit of an aircraft comprising a set of control elements, the display system comprising:
a display device configured to be worn fastened to a head of a user in the cockpit of the aircraft;
a display computer configured to control display of information on the display device;
a sensor of position and of orientation of the head of the user in the cockpit; and
a database comprising information regarding interior geometry of the cockpit,
the display system comprising a mode of operation termed assistance with management of procedures, in which the display computer is configured to:
receive, from a procedures management computer of the aircraft, at least one item of information relating to a first control element of the cockpit on which an action of the user is expected;
acquire, from the database, information regarding position of the first control element in the cockpit;
acquire information, provided by the sensor, regarding position and orientation of the head of the user in the cockpit;
determine a position of display of a symbol on the display device, as a function of the position of the first control element in the cockpit and of the information regarding position and orientation of the head of the user in the cockpit, such that the symbol is visible by the user, superimposed on the first control element; and
command the display of the symbol on the display device.
